(19) United States
(12) Patent Application Publication
(10) Pub. No.: US 2026/0252874 A1
(43) Pub. Date: Aug. 27, 2026

(54) PARALLEL DECODING FOR GENERATIVE MODELS

(71) Applicant: GDM Holding LLC, Mountain View, CA (US)

(72) Inventors: Matthew Sharifi, Kilchberg (CH); Florian Nils Hartmann, Zurich (CH)

(21) Appl. No.: 19/059,811

(22) Filed: Feb. 21, 2025

(51) Int. Cl. G06N 3/08; G06F 40/40

(52) U.S. Cl. CPC G06N 3/08; G06F 40/40

(57) ABSTRACT

Implementations are described herein for parallel decoding for generative models. In various implementations, a computer-implemented method may be provided and include tokenizing an initial query during a prefill phase of a generative model to generate an initial input prompt including a stream of input tokens. The method then forks a decoding phase of the generative model into a plurality of parallel decoding batches based on one or more of the input tokens. This forking includes generating a plurality of sub-inference queries. The method also includes tokenizing the plurality of sub-inference queries into a corresponding plurality of sub-inference input prompts. The method may also include decoding the plurality of sub-inference input prompts in parallel to generate one or more streams of sub-inference output tokens. The one or more streams of sub-inference output tokens are indicative of multiple alternative responses to the initial query.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

Generative models such as large language models (LLMs) and vision language models (VLMs) are applicable across a range of use cases and can be used to generate responses to queries or to provide other types of output in an interactive environment. LLMs are particularly well suited to generating responses based on large, multi-sentence outputs and are often tasked with decoding complex queries with multiple clauses or branching points that may lead to an ensemble of likely outputs from an interactive environment. But generative models in general and LLMs in particular are subject to several limitations. For instance, given the limited ability of computing devices to perform in parallel, LLM inference tends to occur serially, generating one output token at a time until all the tokens have been decoded. This tends to result in a long latency and high computational cost. Moreover, training generative models typically tends to be a slow process, requiring a large number of human-provided queries to train the model.

### SUMMARY

Some autoregressive models, such as decoder-only generative models, operate in a prefill phase and a decoding phase. During the prefill phase, an input query, which may be textual, image-based, audio, or any combination thereof, may be tokenized into a stream of input tokens. During a decoding or inference phase, the input prompts/batches may be decoded by the generative model into a corresponding stream of output tokens, each of which is associated with a likelihood, probability, or other measure of confidence.

With some autoregressive models it may be possible during the prefill stage to group multiple input prompts into batches. Multiple batches may then be processed in parallel, which may be significantly faster on a per-token basis than if the prompts were serially processed by the generative model. Despite the performance gains realized from prefill batching, however, the decoding phase may still present a significant bottleneck because it may be performed in serial.

Implementations are described herein for performing divide-and-conquer inference during the decoding phase of a generative model. More particularly, but not exclusively, implementations are described herein for forking a decoding phase of the generative model into a plurality of parallel decoding batches. For each decoding batch, a respective sub-inference query may be generated and incorporated into a corresponding sub-inference input prompt. Each sub-inference input prompt may be independently decoded (e.g., as a batch) to generate a corresponding sub-inference stream of output tokens. In various implementations, the streams of sub-inference output tokens may be indicative of multiple alternative responses to an initial query. For example, if a user asks, “give me a few ideas for a 7-year-old's birthday party,” each stream of sub-inference output tokens may be indicative of a different type of birthday party, such as pirate-themed, princess-themed, sleepover, etc.

In various implementations, a method implemented using one or more processors may include, during a prefill phase of a generative model, tokenizing an initial query to generate an initial input prompt including a stream of input tokens. Based on one or more of the input tokens, a decoding phase of the generative model may be forked into a plurality of parallel decoding batches. This forking may include generating a plurality of sub-inference queries; tokenizing the plurality of sub-inference queries into a corresponding plurality of sub-inference input prompts; and decoding the plurality of sub-inference input prompts in parallel to generate one or more streams of sub-inference output tokens. The one or more streams of sub-inference output tokens may be indicative of multiple alternative responses to the initial query.

In various implementations, one or more of the streams of sub-inference output tokens may be detokenized into the multiple alternative responses. The multiple alternative responses may be presented on one or more devices. Feedback about one of the multiple alternative responses associated with a given decoding branch of the plurality of decoding branches may be received. Another decoding branch of the plurality of decoding branches may be caused to terminate early based on the feedback. The generative model may be trained based on the feedback.

In various implementations, the initial input prompt may include a command to fork decoding into a plurality of parallel decoding branches when one or more criteria are met. The one or more criteria may include the initial query seeking multiple alternative responses to a single question or command. At least part of the stream of input tokens may be processed using a machine learning classifier to generate forking output, with the forking performed responsive to the forking output. In some implementations, the machine learning classifier may be trained to generate forking output indicative of whether input tokens are suitable for forking. In other implementations, the machine learning classifier may be trained to generate sub-inference queries or sub-inference input prompts. One or more of the input tokens may be decoded to generate one or more pre-fork output tokens that trigger the forking. The pre-fork output tokens may include the plurality of sub-inference queries. The pre-fork output tokens may include a predefined sequence of one or more tokens. One or more of the plurality of sub-inference input prompts may include one or more of the pre-fork output tokens.

The number of sub-inference queries or sub-inference input prompts generated may be selected based at least in part on one or more branching factors. One or more of the input tokens may be decoded to generate one or more pre-fork output tokens that trigger the forking, with one or more of the branching factors determined from one or more of the pre-fork tokens. The one or more branching factors may include a hardware branching factor selected based on computational capacity of one or more computing systems. The one or more branching factors may include a user-selected branching factor specified in the initial query. The one or more branching factors may include two competing branching factors, with the number of sub-inference queries or sub-inference input prompts generated being the greater of the two competing branching factors. One or more of the sub-inference input prompts may include one of the branching factors as a recursive branching factor, with the recursive branching factor triggering recursive forking within the respective decoding batch of the plurality of parallel decoding batches.

One or more of the plurality of sub-inference input prompts may include at least some input tokens of the stream of input tokens. The decoding may include decoding the plurality of sub-inference prompts in parallel to generate a plurality of streams of sub-inference output tokens. The plurality of streams of sub-inference output tokens may be aggregated to generate an aggregated stream of output tokens. The aggregating may include concatenating. At least some input tokens of the stream of input tokens may be decoded in serial subsequent to the forking. A different seed may be included in each of the plurality of sub-inference input prompts.

In various implementations, a method implemented using one or more processors may include providing a training input prompt including a stream of input tokens. During a decoding phase of a pre-trained generative model, the stream of input tokens may be decoded to generate a serial stream of output tokens. The serial stream of output tokens may be annotated to identify a candidate sub-sequence of output tokens for forking. A total perplexity measure corresponding to the stream of input tokens may be calculated. A sub-sequence perplexity measure for the candidate sub-sequence of output tokens may be calculated. The total perplexity measure may be compared to the sub-sequence perplexity measure. Based on the comparing, the training input prompt may be classified as suitable for training. The generative model may be fine-tuned using the classified training input prompt.

Other implementations may include a transitory or non-transitory computer readable storage medium storing instructions executable by a processor to perform a method such as one or more of the methods described above. Yet another implementation may include a control system including memory and one or more processors operable to execute instructions, stored in the memory, to implement one or more modules or engines that, alone or collectively, perform a method such as one or more of the methods described above.

Techniques described herein may address the latency and computational cost of autoregressive decoding in generative model inference by enabling within-request batching during decoding. Branching points may be identified within a query, allowing the response to be divided into independent sub-queries decoded in parallel. In some implementations, each sub-query may use the original prompt, previously decoded tokens, and a sub-query instruction. A branching factor, determined by the generative model, available computational resources, and/or a combination thereof, may govern the number of parallel sub-queries that are forked. To ensure diverse outputs, different random seeds or “salt” may be used for each sub-query. After completion, sub-queries may be concatenated, and decoding may then resume sequentially. This parallel processing reduces latency and computational cost.

The branching operation can be triggered by a special token or sequence generated by the generative model, or by a separate classifier that identifies suitable branching points in the input prompt. The model can be trained to favor early branching and create branches processing a similar number of tokens, thus avoiding a return to sequential decoding. This training may include identifying and verifying candidate branching points using perplexity measures. The user interface can display parallel branches concurrently, enabling user feedback and potential early termination of less relevant branches, which can be used for further model training. If hardware capacity exceeds the user-specified branching factor, excess branches may nonetheless be used to generate additional decoded branches. These previously decoded branches that were not surfaced to the user can be reused if the user requests more results, further reducing latency. In some implementations, recursive branching may be used, subject to hardware limitations. The sub-queries may be designed to be self-contained and independent, ensuring coherent concatenation of results. Techniques described herein may be applicable to any autoregressive model but may be particularly beneficial for generative models such as large language models (LLMs).

### BRIEF DESCRIPTION OF THE DRAWINGS

FIG. 1 shows a schematic diagram of a knowledge system including a prompt assembly engine, a generative model engine, a decoder, and an aggregator.

FIG. 2A shows a schematic diagram illustrating conventional serial decoding of multiple batches of input tokens.

FIG. 2B shows a schematic diagram illustrating parallel decoding of multiple batches of input tokens.

FIG. 3 shows a schematic diagram illustrating parallel streams of sub-inference output tokens being presented and terminated based on user feedback.

FIG. 4 shows a schematic diagram illustrating a branching operation triggered by decoded tokens that initiate parallel decoding branches.

FIG. 5 shows a schematic diagram illustrating a branching operation triggered by a forking classifier that initiates parallel decoding branches.

FIG. 6 shows a flowchart illustrating a method for performing divide-and-conquer inference in a generative model.

FIG. 7 shows a flowchart illustrating a method for training a generative model to identify suitable branching points.

FIG. 8 shows a block diagram of an example computer system.

### DETAILED DESCRIPTION

Implementations are described herein for performing divide-and-conquer inference during the decoding phase of a generative model. More particularly, but not exclusively, implementations are described herein for forking a decoding phase of the generative model into a plurality of parallel decoding batches. For each decoding batch, a respective sub-inference query may be generated and incorporated into a corresponding sub-inference input prompt. Each sub-inference input prompt may be independently decoded to generate a corresponding sub-inference stream of output tokens. In various implementations, the streams of sub-inference output tokens may be indicative of multiple alternative responses to an initial query. For example, if a user asks, “give me a few ideas for a 7-year-old's birthday party,” each stream of sub-inference output tokens may be indicative of a different type of birthday party, such as pirate-themed, princess-themed, sleepover, etc.

In various implementations, during a prefill phase of a pre-trained generative model, an initial query may be tokenized to generate an initial input prompt comprising a stream of input tokens. A decoding phase of the generative model may then be forked into a plurality of parallel decoding batches. In various implementations, this forking may include: generating a plurality of sub-inference queries; tokenizing the plurality of sub-inference queries into a plurality of sub-inference input prompts; and decoding two or more sub-inference input prompts of the plurality of sub-inference input prompts in parallel to generate a stream of sub-inference output tokens. In various implementations, the plurality of streams of sub-inference output tokens may be indicative of multiple alternative responses to the initial query.

In some implementations, the streams of sub-inference output tokens generated in parallel may be aggregated, e.g., using concatenation, and then provided as a single aggregated stream of output tokens. Decoding of any remaining input tokens may then resume in a single thread, e.g., in serial, unless forking is triggered again, at which point the disclosed process may repeat.

The number of parallel streams of sub-inference output tokens that are generated (or forked) may be determined in whole or in part based on one or more branching factors. A branching factor may be set manually and/or determined dynamically. Some branching factors may be hardware-based. For example, if there are eight processors, or a single processor having eight cores, then the hardware-based branching factor may be eight. Other branching factors may be user-based or query-based. For example, if a user issues a generative model query, “give me 10 ideas for a kids birthday party,” then the user-based or query-based branching factor may be ten. Other branching factors may be determined dynamically based on, for instance, a number of active generative model requests being processed. If the system is under heavy strain or has little remaining computational capacity, for instance, the branching factor may be decreased. Conversely, the branching factor may be increased if there is excess computational capacity (e.g., unused processors and/or processor cores).

In some instances, there may be multiple competing or unaligned branching factors in play. For instance, a user may request five different ideas for an anniversary gift, setting a user-based branching factor of five. Meanwhile, the system may include sixteen processors configured to operate in parallel, setting a hardware based branching factor of sixteen (or eight if two threads will be processed by each processor, or four if four threads will be processed by each processor, etc.). In such a scenario, the greater of the two branching factors may be used to control the forked decoding. For example, sixteen different sub-inference prompts may be generated, each with a sub-inference query. In implementations where the sub-inference queries are identical across the different sub-inference prompts, a different seed (e.g., randomly or pseudo-randomly selected) may be included in each sub-inference input prompt. In implementations in which the sub-inference queries themselves vary (e.g., beam searching is leveraged to sample sixteen different sub-inference queries generated from the initial query), the seeds may be optional.

These sixteen sub-inference prompts may then be decoded using the generative model to generate sixteen streams of sub-inference output tokens. Each stream of sub-inference tokens may identify a different candidate anniversary gift. Since the user only requested five ideas, five of these sixteen candidate gift ideas may be surfaced to the user initially. However, if the user is unsatisfied and requests more gift ideas, one or more of the eleven un-surfaced gift ideas may then be surfaced to the user first, e.g., before additional generative model processing is performed to generate yet additional anniversary gift ideas. This may reduce the latency experienced by the user even further.

In some implementations, a user may have control over the decoding performed for each parallel batch. For example, the stream of sub-inference output tokens may be detokenized into content that contains multiple alternative responses, which may be presented or surfaced using one or more devices, such as a display or speaker. In some implementations, these tokens may be surfaced as they are generated, in a streaming manner, while the decoding continues. In some implementations, surfaced tokens may be presented along with names generated for their corresponding threads (e.g., “necklaces,” “rings,” “spa treatments”).

The user may be able to provide feedback about one the multiple alternative responses associated with a given decoding branch while that branch and/or other branches continue decoding. For example, the user may select one of the candidate anniversary gift ideas to navigate a computing device to a procurement interface that enables the user to procure the selected anniversary gift. Meanwhile, decoding branches that are still generating output tokens may be terminated early, which may conserve considerable resources. Additionally, in some implementations, the generative model may be trained based on the user's feedback, e.g., using reinforcement learning with human feedback (RLHF) or similar techniques.

The forking of the decoding phase may be triggered in various ways. In some implementations, the stream of input tokens generated during the prefill phase may be evaluated prior to decoding to determine whether forking should be triggered. For example, a machine learning classifier (e.g., a generative model such as an LLM or another type of machine learning model such as various types of neural networks (e.g., recurrent), decision trees, random forests, etc.) may be trained to generate forking output that is indicative of whether the input tokens are suitable for forking. In some such implementations, the machine learning classifier may be trained to generate sub-inference queries or sub-inference input prompts.

In other implementations, the generative model itself may be leveraged to automatically fork decoding into multiple parallel decoding batches. For example, input token(s) may be decoded prior to forking to generate pre-fork output token(s). One or more of these pre-fork output token(s) themselves may trigger the forking. For example, an explicit command to fork (or attempt to fork, if possible) the decoding into N branches may include in the initial input prompt, e.g., as part of the initial query or separately (e.g., as a system prompt).

Additionally or alternatively, the generative model may be trained and/or fine-tuned to automatically fork decoding into multiple parallel decoding batches. As a result, the generative model may decode pre-fork output tokens that include, for instance, multiple sub-inference queries, e.g., with a command to fork the multiple sub-inference queries into corresponding parallel decoding batches. Alternatively, the decoded pre-fork output tokens may include predefined sequence(s) of token(s) that are specifically designed to trigger forking, such as “begin fork with N branches here” or similar. In various implementations, the generative model may be fine-tuned to “learn” when/how to trigger forking by processing training examples using a pre-trained generative model. The training examples may include, or may be assembled along with, annotations that identify candidate sub-sequences of tokens that may be suitable for forking, e.g., be showing branching could start and end, boundaries between independent sub-sequences, etc. These candidate sub-sequences may be verified in some implementations using a perplexity measure. If the perplexity measure of a given sub-sequence of tokens is less than or similar to the perplexity of the entire stream of input tokens, that may be a good indication of whether the sub-sequences have any dependencies or can in fact be decoded in parallel. The synthesized and perplexity-filtered training data may then be used for fine-tuning the generative such that it becomes branching-aware.

Techniques described herein may give rise to various technical advantages. Forking the decoding phase of a generative model into multiple parallel branches may allow for multiple different logics, such as multiple central processing units (CPUs), graphics processing units (GPUs), tensor processing units (TPUs), neural processing units (NPUs), or different cores within these units (which may include many cores), application-specific integrated circuits (ASICs), field-programmable gate arrays (FPGAs), etc., to be operated in parallel to process multiple different sub-inference prompts at once. This may significantly reduce latency and/or increase throughput. Moreover, allowing a user to select responsive content generated from one branch may allow the other parallel branches to be terminated early, conserving additional computational resources.

In various implementations, efforts may be made to cause inference to fork into parallel branches as early as possible. In such cases, a visualization of a tree representing the forking would preferably be wide, rather than deep, as measured by the number of tokens of each node. This may be accomplished in various ways. In some implementations, the generative model may sample different ways of decoding and forking, and select those ways that achieve a desirable perplexity measure while also having desirable branching properties (e.g., wide rather than deep).

In some implementations, it may be desirable for the decomposition to decode a similar number of tokens in each forked branch. Otherwise, if one branch decodes significantly more data than other branch(es), performance converges back towards sequential autoregressive decoding which does not allow batching. Teaching the generative model to fork into branches that decode a similar number of tokens can be achieved in various ways, such as by filtering or weighing the fine tuning examples. Additionally or alternatively, in some implementations, a loss term could be added to input prompts to encourage branches having similar numbers of tokens, e.g., by adding a length variance to a loss function that is then minimized during training.

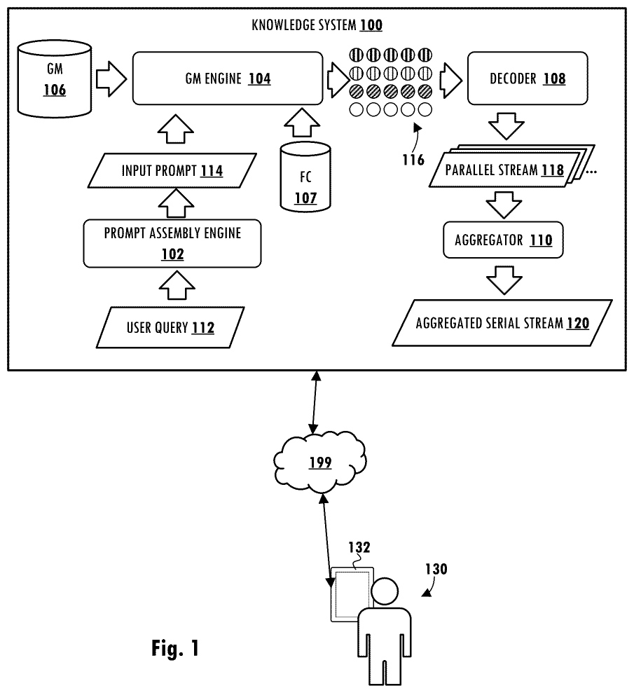

FIG. 1 is a schematic diagram illustrating components that can cooperate to carry out selected aspects of the present disclosure, in accordance with various implementations. The various components depicted in FIG. 1, particularly those components forming a knowledge system 100, may be implemented using any combination of hardware and software. The components of FIG. 1 are depicted as being communicatively coupled with each other via one or more networks 199, which may include one or more personal area networks, local area networks, and/or wide area networks (e.g., the Internet). However, this is not meant to be limiting. Various aspects of the present disclosure that are described as being performed by and/or stored on system 100 can alternatively be performed by and/or stored elsewhere and/or distributed across multiple systems, such as between system 100 and a client device 132.

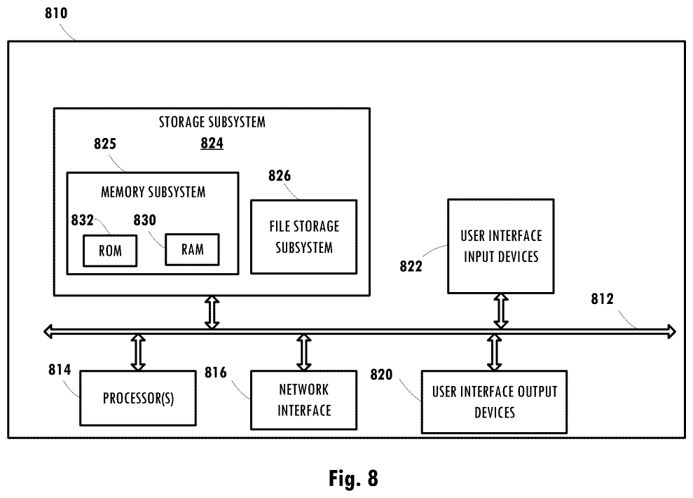

In some implementations, knowledge system 100 may include one or more computing devices cooperating to perform selected aspects of the present disclosure. An example of such a computing device is depicted schematically in FIG. 8. In some implementations, knowledge system 100 may include one or more servers forming part of what is often referred to as a “cloud” infrastructure, or simply “the cloud.” Alternatively, one or more components of system 100 may be operated by client device 132.

Knowledge system 100 may include a prompt assembly engine 102, a generative model (GM) engine 104 with access to one or more generative models (GM) 106, a decoder 108, and an aggregator 110. Any of elements 102-110 may be implemented using any combination of hardware and software. Moreover, any of elements 102-110 may be combined with other(s) of elements 102-110.

Generative models 106 may take various forms, including, but not limited to, model(s) such as Gemini, Flamingo, PaLM, BERT, LaMDA, Meena, and/or any other single-modal or multimodal generative model, such as any other generative model that is encoder-decoder-based, encoder-only based, decoder-only based, sequence-to-sequence based and that optionally includes an attention mechanism or other memory, diffusion model(s), etc. Generative models may have hundreds of millions, or even hundreds of billions of parameters.

In various implementations, a user 130 may interact with knowledge system 100 using a client device 132. While depicted as a tablet computer or smart phone in FIG. 1, client device 132 may take other forms, such as a desktop or laptop computer, in-vehicle computing device, augmented reality (AR) and/or virtual reality (VR) headset or glasses, standalone “smart” speakers that host automated assistants that can be interacted with, etc.

In various implementations, a user 130 may operate client device 132 to provide various types of conditioning data to knowledge system 100 to cause prompt assembly engine 102 to assemble an input prompt 114. For example, user 130 may operate client device 132 to submit a query that is suitable for parallelization as described herein, such as “Give me five ideas for surprise party themes” or “find the highest rated new vehicle in each price range of $30,000-$40,000, $40,000-$50,000, $50,000-$60,000, and $60,000-$70,000.” This natural language may be tokenized by prompt assembly engine 102 into input prompt, e.g., along with other data, such as an explicit branching factor (e.g., a manually-set default branching factor), a dynamic branching factor (e.g., the number of processors/cores available for parallelization), preferences of the user (e.g., they may prefer sports-utility vehicles over sedans), contextual information (e.g., location of the user, which could influence prices), and so forth.

As will be explained in more detail below, input prompt 114 may be processed by GM engine 104, e.g., using all or part of one or more generative models 106, to generate prefill representations 116. As indicated by the multiple rows of circles, the prefill representations 116 may be provided in parallel because the prefill stage is typically performed in parallel, with each batch receiving its own fork. Prefill representations 116 may in turn be processed by decoder 108 to generate parallel streams 118 of sub-inference output tokens. In various implementations, aggregator 110 may aggregate (e.g., via concatenation, averaging, etc.) the parallel streams 118 of sub-inference output tokens to generate an aggregated serial stream of output tokens 120.

In some implementations, GM engine 104 or another component may use a forking classifier (FC) 107 to determine whether to fork decoding into multiple parallel branches. Forking classifier 107 may be, for instance, various types of machine learning models, such as a generative model, various types of feed-forward neural networks (e.g., recurrent, convolutional), a decision tree, random forest, etc. In various implementations, GM engine 104 or another component may process the user query 112, input prompt 114, and/or prefill tokens 116 to detect branchable queries and propose appropriate sub-inference prompt(s). These prompts may then be processed (e.g., decoded) by GM engine 104, e.g., in parallel.

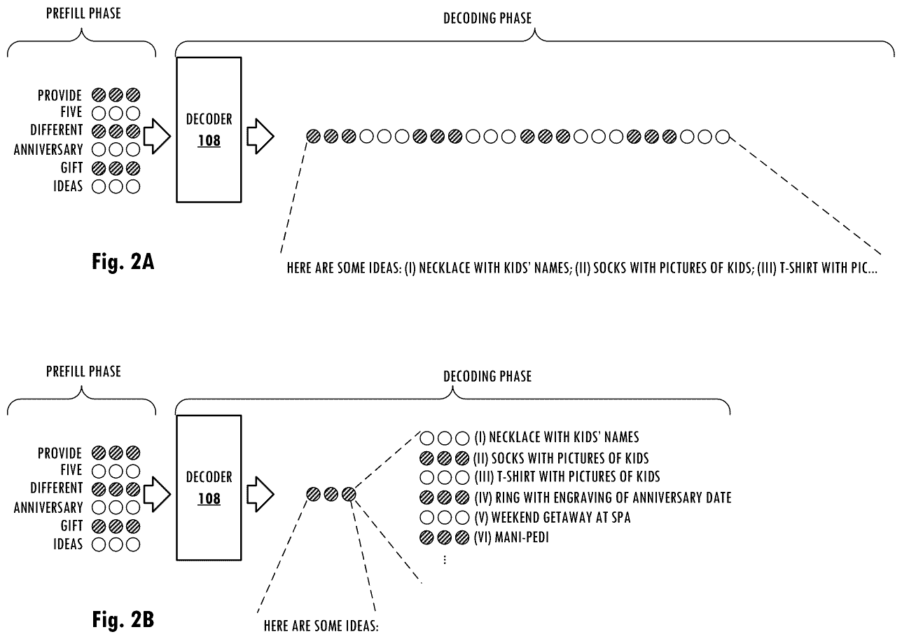

FIG. 2A schematically depicts an example of how decoder 108 of knowledge system 100 may conventionally process multiple parallel batches of input/prefill tokens to generate a single serial stream of output inference tokens. Here, the user's query was “provide five different anniversary gift ideas.” Each word of this query is encoded (as represented by the circles) into its own batch, and the six rows of circles correspond to six batches of embeddings that are provided to decoder 108 in parallel. As mentioned previously, with many generative models, the decoder portion is autoregressive. Consequently, the decoder decodes output tokens in serial in FIG. 2A: “Here are some ideas: (I) necklace with kids' names, (II) socks with pictures of kids, (III) t-shirt with pic . . . .” This may create a bottleneck that introduces latency to the user.

FIG. 2B schematically depicts an example of selected aspects of the present disclosure that may be implemented to cause parallel decoding by decoder 108 of knowledge system 100. In various implementations, a decoding phase of the generative model implemented by decoder 108 may be forked into a plurality of parallel decoding batches. This forking may include, for instance, generating a plurality of sub-inference queries, which may be tokenized into a corresponding plurality of sub-inference input prompts. These sub-inference queries may be identical to each other or different. In the former case, a different random seed may be added to each sub-inference query so that the plurality of sub-inference input prompts are different from each other and return different content. On the other hand, if the sub-inference queries are different (e.g., “find me the highest rated vehicle from $30,000-$40,000,” “find me the highest rated vehicle from $30,000-$40,000,” . . . ), then a random seed may or may not be used.

As shown in FIG. 2B, the decoder 108 may decode the plurality of sub-inference input prompts in parallel to generate multiple more streams of sub-inference output tokens that are indicative of multiple alternative responses to the initial query. In FIG. 2B, for instance, an initial stream of inference output tokens conveys the response preamble, “Here are some ideas:”. This is followed by a first parallel stream of sub-inference output tokens conveys the response, “(I) Necklace with kids' names,” another parallel stream of sub-inference output tokens conveys the response, “(II) Socks with pictures of kids,” another parallel stream of sub-inference output tokens conveys the response, “(III) t-shirt with pictures of kids,” another parallel stream of sub-inference output tokens conveys the response, “(IV) ring with engraving of anniversary date,” another parallel stream of sub-inference output tokens conveys the response, “(V) Weekend getaway at spa,” and another parallel stream of sub-inference output tokens conveys the response, “(VI) mani-pedi.” As indicated by the ellipses, there can be any number of additional parallel sub-inference output streams depending on, for instance, branching factors in play, hardware availability, etc. Even though FIGS. 2A and 2B are schematic in nature and not necessarily drawn to scale, it is evident that the embodiment depicted in FIG. 2B is able to present responsive information with considerably less latency.

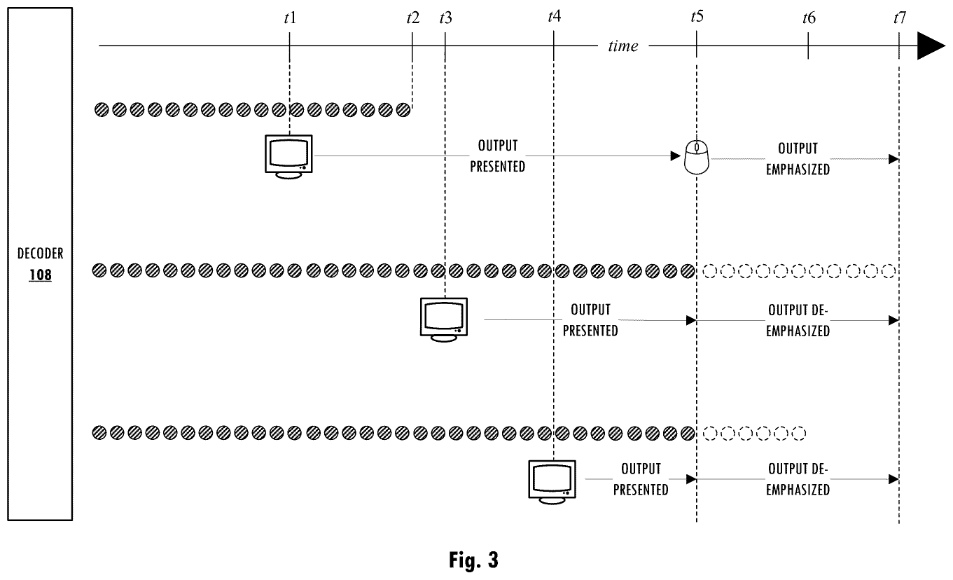

FIG. 3 schematically depicts an example of how multiple parallel streams of sub-inference output tokens may be generated along a timeline (as indicated by the right-to-left arrow). In particular, FIG. 3 demonstrates how the multiple alternative responses represented in the multiple parallel streams of sub-inference output tokens may be presented on one or more devices (e.g., displays, speakers, augmented reality devices, virtual reality devices, etc.), where user(s) (not depicted) may be able to provide feedback on each stream in real time, such that decoding of one or more of the parallel streams could be terminated early. This may conserve considerable compute resources such as memory, processor cycles, etc.

Three parallel streams of sub-inference output tokens are generated by decoder 108 in FIG. 3. At time t1, responsive output contained in and/or derived from the top stream begins to be presented, e.g., on a display device, in real time. For example, responsive natural language may begin to appear one or more words at a time. At time t2, the top stream completes decoding, at which point no more responsive content is rendered on the display.

At time t3, responsive content contained in and/or derived from the middle stream begins to be presented, e.g., on the same display device as the responsive content from the top stream, on a different display device, or even in a different modality (e.g., via speech-to-text output rendered on a speaker). Similarly, at time t4, responsive content contained in and/or derived from the bottom stream begins to be presented, e.g., on the same display device as the responsive content from the other streams, on a different display device, or even in a different modality.

In various implementations, decoding and/or rendition of output of one or more of the parallel streams of sub-inference output tokens may be terminated early based on feedback received about one the multiple alternative responses associated with a given decoding branch of the plurality of decoding branches. To demonstrate, suppose the user requested ideas for a child's birthday party theme. The responsive content contained in and/or derived from the top stream of sub-inference output tokens may relate to superheroes. The responsive content contained in and/or derived from the middle stream of sub-inference output tokens may relate to sports. The responsive content contained in and/or derived from the bottom stream of sub-inference output tokens may relate to video games. As indicated by the mouse symbol, at time t5, the user selects the responsive content that was contained in and/or derived from the top stream of sub-inference output tokens, which relates to superheroes. For example, one or more hyperlinks or other selectable elements may be presented as part of the responsive content associated with the top stream of sub-inference output tokens.

At time t5, the responsive content for the top stream was already completely rendered. The responsive content for the middle and bottom streams continued to be rendered as it was decoded, e.g., in real time. Accordingly, and assuming all three responsive contents were presented on the same display, the user at time t5 may have observed the top responsive content to have completed, while the middle and bottom responsive contents continued to be rendered. Nonetheless, the user was satisfied with the superhero option, and so at time t5 they selected a selectable element rendered in association with the top stream. As a result, the decoding of the middle and bottom streams ceases at time t5 since the user is no longer interested in those streams.

Additionally, in some implementations, the selected responsive content (top stream in FIG. 3) may be emphasized, e.g., visual, audibly, etc. For example, the selected responsive content may be highlighted rendered in a different font, size, color, may be rendered in a new window or tab, etc. By contrast, the responsive content rendered from the middle and bottom streams of sub-inference output tokens may be de-emphasized beginning at time t5. For example, they may be rendered in a smaller font, a less conspicuous color, etc. As indicated by the dashed circles, at time t6, the decoding of the bottom stream would have otherwise been completed. Accordingly, by terminating early, the computational resources that would have been used to generate those last tokens of the bottom stream subsequent to time t5 are conserved. Similarly, at time t7, the decoding of the middle stream would have otherwise been completed. Accordingly, by terminating early, the computational resources that would have been used to generate those last tokens of the middle stream subsequent to time t5 are conserved.

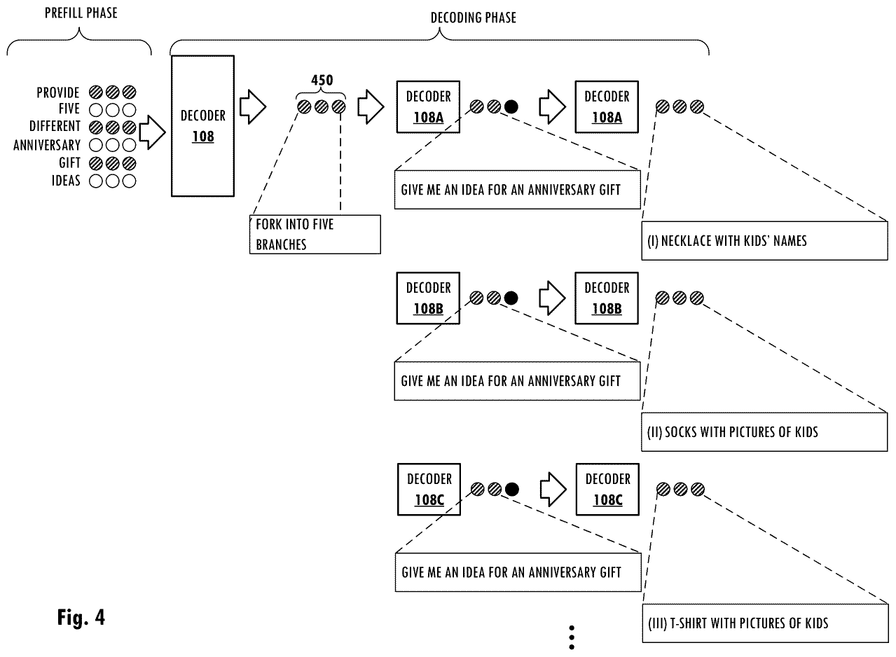

Decoding may be forked into multiple branches in various ways. FIG. 4 schematically depicts one example of how decoding may be forked into multiple branches. In this example, a prefill phase is depicted at left and the decoding phase is depicted at right, similar to previous figures. During the prefill phase, the query “Provide five different anniversary gift ideas” is tokenized into the six rows of parallel embeddings/batches (each embedding represented by three circles, which is for illustrative purposes only and is not meant to be limiting). Decoder 108 then begins decoding these embeddings in serial to generate serial output tokens 450 that convey the command, “Fork into five branches.”

Based on this command, decoder 108 and/or GM engine 104 may instantiate/fork into five branches, each including a respective instance of a decoder 108 (e.g., 108A in the top branch, 108B in the second branch down, 108C in the third branch down, etc.). Each branch may then include a workflow in which the respective instance of decoder 108 decodes a respective sub-inference query (“Give me an idea for an anniversary gift”).

If there are sufficient computational resources (e.g., processors, cores, memory, virtual machines, containers, etc.), then at least five branches will be instantiated per the user's request. If there are not sufficient computational resources (e.g., only four processors available), then as many branches may be instantiated as possible. If there are more than enough computational resources available, then more than five branches may be instantiated, each with a different random seed. However, the user may only be presented with responsive content derived from five of those branches, at least initially. The remaining unsurfaced responsive content may be cached (e.g., locally at client device 132), e.g., so that the user can surface those (if they're not satisfied with the initial five results) with minimal latency (e.g., no additional generative model processing would be required).

In this example, each branch is provided with a different random seed, represented by the black circle. Consequently, the same command (“Give me an idea for an anniversary gift”) can be processed by generative model engine 104 using a decoder portion of generative model 106 multiple times. However, the responsive content generated is different for each branch. For instance, the top branch generates the responsive content, “(I) Necklace with kids' names,” the second branch generates the responsive content, “(II) Socks with pictures of kids,” the third branch generates the responsive content, “(III) T-shirt with pictures of kids,” and so on.

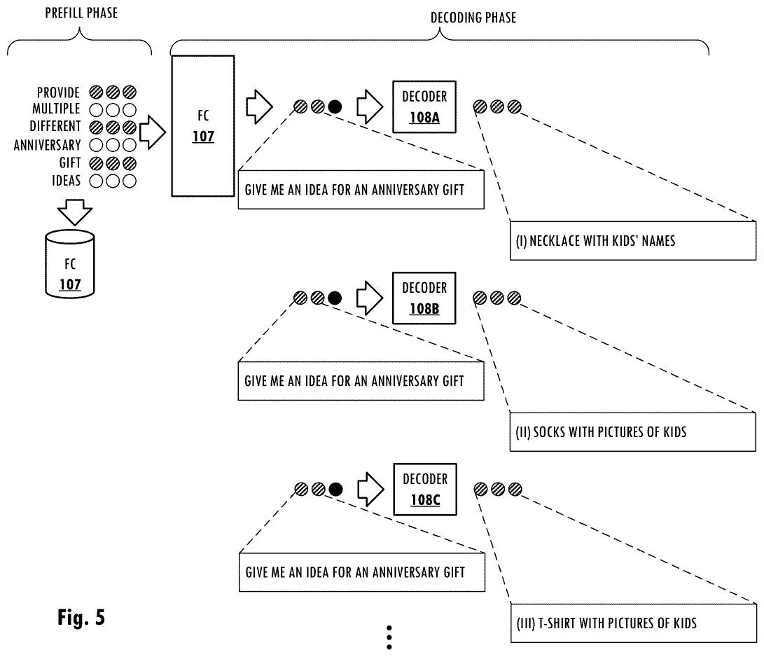

FIG. 5 schematically depicts another example of how decoding may be forked into multiple branches. In this example, a prefill phase is once again depicted at left and the decoding phase is depicted at right. During the prefill phase, the query “Provide five different anniversary gift ideas” is once again tokenized into the six rows of parallel embeddings/batches. However, instead of these parallel embeddings/batches being processed via decoder 108 initially, they are instead processed based on forking classifier 107. As noted above, forking classifier 107 is a trained machine learning model. It may take the form of a generative model, or another form, such as one or more neural networks such as one or more recurrent neural networks, a random forest, decision tree, etc.

Forking classifier 107 in this example generates the same sub-inference query multiple times, with each instance being seeded with different random data (as represented by the black circle), similar to FIG. 4. These sub-inference queries generated using forking classifier 107 are then decoded via decoder 108 into different responsive content in each thread, similar to FIG. 4. While the same sub-inference queries are depicted in FIG. 5 as were shown in FIG. 4, this is not meant to be limiting. The random seeds effectively make the generation of the responsive content nondeterministic.

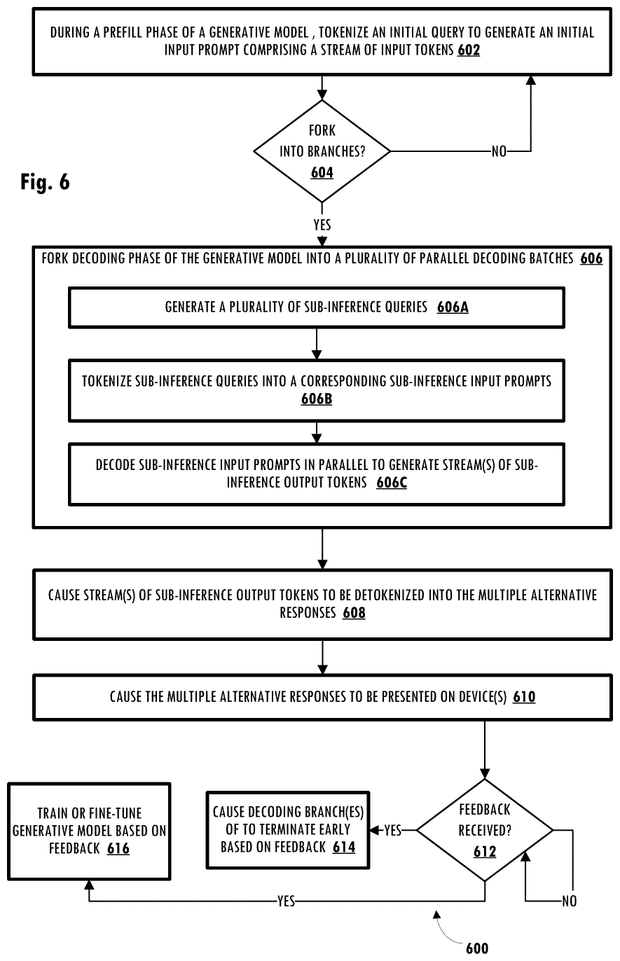

FIG. 6 schematically depicts an example method 600 for practicing selected aspects of the present disclosure. For convenience, method 600 will be described as being performed by one or more computing devices, such as knowledge system 100 of FIG. 1 implementing at least some aspects of the present disclosure. The particular operations depicted in FIG. 6 are not meant to be limiting. One or more operations may be performed without others, in a different order than shown, etc.

During a prefill phase, the system may tokenize an initial query to generate an initial input prompt (e.g., 114) including a stream of input tokens, e.g., using prompt assembly engine 102 as shown in FIG. 1. At block 604, the system may determine whether to fork the decoding phase into multiple branches. The system may make this determination in various ways. As shown in FIG. 4, for instance, decoder 108 may begin decoding tokens, and if the generative model is trained to detect suitable situations for forking, then the decoded tokens may initially include a forking command. Alternatively, and as shown in FIG. 5, the system may utilize forking classifier 107 to process the input prompt (e.g., 114) and generate output indicating that forking is appropriate, e.g., as a command or as a plurality of sub-inference queries.

If the answer at block 604 is no, method 600 may return to block 602. However, if the answer at block 604 is yes, then method 600 may proceed to block 606. At block 606, the system may fork a decoding phase of the generative model (106) into a plurality of parallel decoding batches based on one or more of the input tokens. This forking may include, at block 606A, generating a plurality of sub-inference queries, e.g., using decoder 108 as shown in FIG. 4 and/or using forking classifier 107 as shown in FIG. 5. At block 606B, the system, e.g., by way of prompt assembly engine 102, decoder 108, and/or GM engine 104, may tokenize the plurality of sub-inference queries into a corresponding plurality of sub-inference input prompts. At block 606C, the system may decode the plurality of sub-inference input prompts in parallel to generate one or more streams of sub-inference output tokens using decoder 108 as shown in FIG. 1. The one or more streams of sub-inference output tokens may be indicative of multiple alternative responses to the initial query, as shown in FIG. 2B. In some implementations, each parallel stream of sub-inference output tokens may be generated by a different processor, processor core, virtual machine instance, container, etc.

At block 608, the system may cause one or more of the streams of sub-inference output tokens to be detokenized into the multiple alternative responses, as shown in FIG. 3. At block 610, the system may cause the multiple alternative responses to be presented on one or more devices, as shown in FIG. 3. At block 612, the system may determine whether feedback was received about one of the multiple alternative responses associated with a given decoding branch of the plurality of decoding branches, as shown in FIG. 3. If the answer at block 612 is no, then method 600 may remain at block 612 or end. However, if the answer at block 612 is yes, then method 600 may proceed to block 614. At block 614, the system may cause another decoding branch of the plurality of decoding branches that has yet to complete decoding to terminate early based on the feedback, as shown in FIG. 3. Additionally or alternatively, if the answer at block 614 is yes, method 600 may proceed to block 616, at which point the system may train (e.g., fine-tune) the generative model (e.g., 106) based on the feedback. Various techniques may be used to train and/or fine-tune the generative model, including but not limited to gradient descent, cross entropy, back propagation, etc.

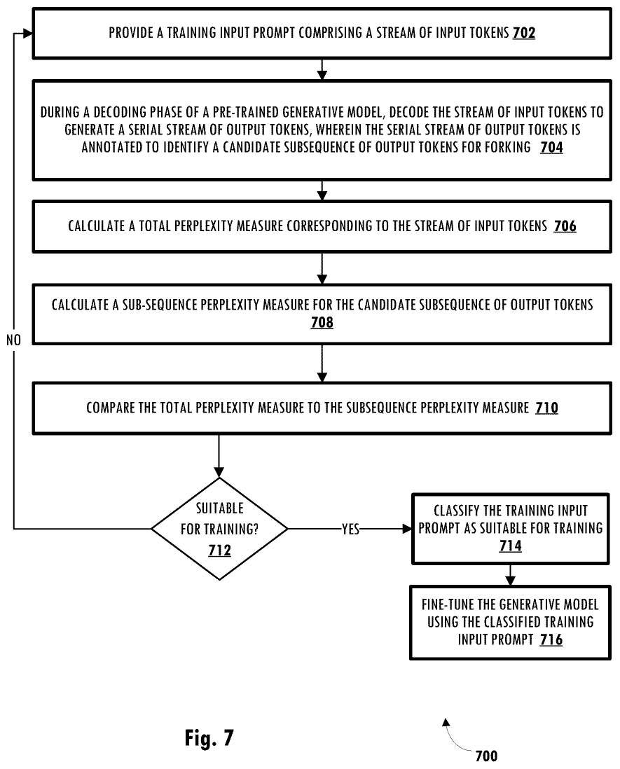

FIG. 7 schematically depicts another example method 700 for practicing selected aspects of the present disclosure. For convenience, FIG. 7 will be described as being performed by one or more computing devices, such as knowledge system 100 of FIG. 1 implementing at least some aspects of the present disclosure. The particular operations depicted in FIG. 7 are not meant to be limiting. One or more operations may be performed without others, in a different order than shown, etc.

At block 702, the system may provide a training input prompt including a stream of input tokens. This prompt may be assembled by prompt assembly engine 102 (FIG. 1) and may include a query similar to those described above. At block 704, the system may, during a decoding phase of a pre-trained generative model 106 (FIG. 1), decode the stream of input tokens to generate a serial stream of output tokens. In some implementations, this stream of input tokens may include a request or command for the generative model to add annotation(s) to the decoding stream at location(s) that are predicted to be suitable for branching. This decoding may be performed by decoder 108 (FIG. 1). The serial stream of output tokens may be annotated to identify one or more candidate sub-sequences of output tokens for forking.

At block 706, the system may calculate a total perplexity measure corresponding to the stream of input tokens. The perplexity measure may be a metric used in evaluating generative models. In some implementations, the perplexity measure PPL may be calculated as follows for the tokenized sequence X=(x₁, x₂, . . . , xₜ), although this is not meant to be limiting:

$$PPL ( X ) = exp \{ - \frac{1}{t} {\sum }_{i}^{t} log {p}_{θ} ( {x}_{i} \vert {x}_{< i} ) \}$$

log log p_{θ}(xᵢ|x_{<i}) may correspond to the log-likelihood of the ith token conditioned on the preceding tokens x_{<i}.

At block 708, the system may calculate one or more sub-sequence perplexity measures for the one or more candidate sub-sequences of output tokens identified in block 704. This measure assesses the perplexity of each candidate sub-sequence independently.

At block 710, the system may compare the total perplexity measure to the sub-sequence perplexity measure(s). At block 712, the system may determine whether the candidate sub-sequence(s) are suitable for training based on the comparison performed at block 710. This determination may be based on various factors, such as a threshold or other criteria comparing the total and sub-sequence perplexity measures. For example, a low sub-sequence perplexity relative to the total perplexity suggests the candidate sub-sequence is relatively independent and suitable for forking. A high sub-sequence perplexity relative to the total perplexity suggests the candidate sub-sequence may be more dependent and/or may not be as suitable for forking.

If the answer at block 712 is no, then method 700 may return to block 702. However, if the answer at block 712 is yes, then method 700 may proceed to block 714. At block 714, the system may classify the sub-sequence(s) as suitable for training. At block 716, the system, e.g., by way of GM engine 104, may fine-tune the generative model 106 (FIG. 1) using the classified training input prompt. This fine-tuning may use techniques such as those described above.

FIG. 8 is a block diagram of an example computer system 810. Computer system 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computer system 810. Network interface subsystem 816 provides an interface to outside networks and is coupled to corresponding interface devices in other computer systems.

User interface input devices 822 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computer system 810 or onto a communication network.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 810 to the user or to another machine or computer system.

Storage subsystem 824 stores programming and data constructs that provide the functionality of some or all of the modules described herein. For example, the storage subsystem 824 may include the logic to perform selected aspects of method 600 or 700, and/or to implement one or more aspects of the various components depicted in FIG. 1. Memory 825 used in the storage subsystem 824 can include a number of memories including a main random-access memory (RAM) 830 for storage of instructions and data during program execution and a read only memory (ROM) 832 in which fixed instructions are stored. A file storage subsystem 826 can provide persistent storage for program and data files, and may include a hard disk drive, a CD-ROM drive, an optical drive, or removable media cartridges. Modules implementing the functionality of certain implementations may be stored by file storage subsystem 826 in the storage subsystem 824, or in other machines accessible by the processor(s) 814.

Bus subsystem 812 provides a mechanism for letting the various components and subsystems of computer system 810 communicate with each other as intended. Although bus subsystem 812 is shown schematically as a single bus, alternative implementations of the bus subsystem may use multiple buses.

Computer system 810 can be of varying types including a workstation, server, computing cluster, blade server, server farm, smart phone, smart watch, smart glasses, set top box, tablet computer, laptop, or any other data processing system or computing device. Due to the ever-changing nature of computers and networks, the description of computer system 810 depicted in FIG. 8 is intended only as a specific example for purposes of illustrating some implementations. Many other configurations of computer system 810 are possible having more or fewer components than the computer system depicted in FIG. 8.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. These processes and logic flows can be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can utilize any type of central processing unit (CPU) graphics processing units (GPUs), tensor processing units (TPUs), and other machine learning accelerators. GPUs, TPUs, and other machine learning accelerators may be employed to enhance performance, particularly for tasks involving artificial intelligence and machine learning. These accelerators may work in conjunction with CPUs, handling specialized computations while the CPU manages overall system operations and other tasks. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

In situations in which the systems described herein collect or otherwise monitor personal information about users (or make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors, comprising:
during a prefill phase of a generative model, tokenizing an initial query to generate an initial input prompt comprising a stream of input tokens;
based on one or more of the input tokens, forking a decoding phase of the generative model into a plurality of parallel decoding batches, wherein the forking comprises:
generating a plurality of sub-inference queries;
tokenizing the plurality of sub-inference queries into a corresponding plurality of sub-inference input prompts; and
decoding the plurality of sub-inference input prompts in parallel to generate one or more streams of sub-inference output tokens, wherein the one or more streams of sub-inference output tokens are indicative of multiple alternative responses to the initial query.

2. The method of claim 1, further comprising causing one or more of the streams of sub-inference output tokens to be detokenized into the multiple alternative responses.

3. The method of claim 2, further comprising:
causing the multiple alternative responses to be presented on one or more devices; and
receiving feedback about one the multiple alternative responses associated with a given decoding branch of the plurality of parallel decoding branches.

4. The method of claim 3, further comprising causing another decoding branch of the plurality of parallel decoding branches to terminate early based on the feedback.

5. The method of claim 3, further comprising training the generative model based on the feedback.

6. The method of claim 1, wherein the initial input prompt comprises a command to fork decoding into a plurality of parallel decoding branches when one or more criteria are met.

7. The method of claim 1, further comprising processing at least part of the stream of input tokens using a machine learning classifier to generate forking output, wherein the forking is performed responsive to the forking output, and wherein the machine learning classifier is trained to generate forking output that is indicative of whether input tokens are suitable for forking.

8. The method of claim 1, further comprising decoding one or more of the input tokens to generate one or more pre-fork output tokens that trigger the forking.

9. The method of claim 8, wherein the pre-fork output tokens comprise:
the plurality of sub-inference queries; or
a predefined sequence of one or more tokens.

10. The method of claim 8, wherein one or more of the plurality of sub-inference input prompts includes one or more of the pre-fork output tokens.

11. The method of claim 1, wherein a number of sub-inference queries or sub-inference input prompts that are generated is selected based at least in part on one or more branching factors.

12. The method of claim 11, further comprising decoding one or more of the input tokens to generate one or more pre-fork output tokens that trigger the forking, wherein one or more of the branching factors is determined from one or more of the pre-fork tokens.

13. The method of claim 11, wherein the one or more branching factors comprise:
a hardware branching factor that is selected based on computational capacity of one or more computing systems;
a user-selected branching factor that is specified in the initial query; or
two competing branching factors, wherein the number of sub-inference queries or sub-inference input prompts that are generated is the greater of the two competing branching factors.

14. The method of claim 11, wherein one or more of the sub-inference input prompts includes one of the branching factors as a recursive branching factor, wherein the recursive branching factor triggers recursive forking within the respective decoding batch of the plurality of parallel decoding batches.

15. The method of claim 1, wherein the decoding includes decoding the plurality of sub-inference prompts in parallel to generate a plurality of streams of sub-inference output tokens.

16. The method of claim 15, further comprising aggregating the plurality of streams of sub-inference output tokens to generate an aggregated stream of output tokens.

17. The method of claim 1, wherein a different seed is used in each of the plurality of sub-inference input prompts.

18. The method of claim 1, wherein the generative model comprises a large language model (LLM), a self-attention transformer model, or a vision language model (VLM).

19. A method implemented using one or more processors, comprising:
providing a training input prompt comprising a stream of input tokens;
during a decoding phase of a pre-trained generative model, decoding the stream of input tokens to generate a serial stream of output tokens, wherein the serial stream of output tokens is annotated to identify a candidate sub-sequence of output tokens for forking;
calculating a total perplexity measure corresponding to the stream of input tokens;
calculating a sub-sequence perplexity measure for the candidate sub-sequence of output tokens;
comparing the total perplexity measure to the sub-sequence perplexity measure;
based on the comparing, classifying the training input prompt as suitable for training; and
fine-tuning the generative model using the classified training input prompt.

20. A system comprising one or more processors and memory storing instructions that, in response to execution of the instructions by the one or more processors, cause the one or more processors to:
during a prefill phase of a generative model, tokenize an initial query to generate an initial input prompt comprising a stream of input tokens;
based on one or more of the input tokens, fork a decoding phase of the generative model into a plurality of parallel decoding batches, wherein the instructions to fork include instructions to:
generate a plurality of sub-inference queries;
tokenize the plurality of sub-inference queries into a corresponding plurality of sub-inference input prompts; and
decode the plurality of sub-inference input prompts in parallel to generate one or more streams of sub-inference output tokens, wherein the one or more streams of sub-inference output tokens are indicative of multiple alternative responses to the initial query.
